(19) United States
(12) Patent Application Publication
(10) Pub. No.: US 2021/0179049 A1
(43) Pub. Date: Jun. 17, 2021

(54) RESERVOIR TANK

(71) Applicant: Bosch Corporation, Tokyo (JP)

(72) Inventor: Ryota Ishii, Saitama (JP)

(21) Appl. No.: 17/124,669

(22) Filed: Dec. 17, 2020

(30) Foreign Application Priority Data
Dec. 17, 2019 (JP) 2019-226922

(51) Int. Cl. B60T 11/26; B60T 17/06

(52) U.S. Cl. CPC B60T 11/26; B60T 17/06

(57) ABSTRACT

In a state where a reservoir tank is mounted on a vehicle, a top surface of a first storage chamber is inclined relative to a horizontal plane so that a height position (H1) of a connection part with a first fluid passage is highest, a top surface of a second storage chamber is inclined relative to the horizontal plane so that a height position (H3) of any one position adjacent to a first partitioning part of a first rib is highest, and the height position (H1) of the connection part with the first fluid passage of the top surface of the first storage chamber, a height position (H2) of a connection part with the first storage chamber of a top surface of the first fluid passage, the height position (H3) of any one position of the top surface of the second storage chamber, a height position (H4) of a connection part with the second storage chamber of a top surface of a second fluid passage, and a height position (H5) of a connection part with a space on one side further from the second storage chamber of the top surface of the second fluid passage satisfy a relation of H1≤H2<H3≤H4<H5.

### BACKGROUND OF THE INVENTION

The present invention relates to a reservoir tank that is used for a hydraulic system.

In the related art, a hydraulic brake device and a hydraulic clutch device are known as a hydraulic system using a hydraulic pressure. The hydraulic systems each have a master cylinder configured to generate a hydraulic pressure and a reservoir tank configured to store a hydraulic fluid. In a case where the hydraulic system is used for a vehicle, the reservoir tank is designed so as to store a sufficient quantity of hydraulic oil in a storage chamber so that a supply port configured to supply the hydraulic oil from the reservoir tank to the master cylinder does not run out of the hydraulic oil due to inclination of the vehicle while traveling on a ramp or during acceleration/deceleration.

For example, WO2015/064638 discloses a reservoir tank where an inlet for injecting a liquid from an outside into a storage chamber in which hydraulic oil is stored is provided on one side of a vehicle, a communication passage extending from the inlet toward the other side of the vehicle is provided, a communication opening configured to enable communication between the communication passage and the storage chamber is formed, and an upper part of the storage chamber is formed with a surface part configured to be higher from the one side of the vehicle toward the communication opening on the other side in a state where the storage chamber is mounted on the vehicle.

### SUMMARY OF THE INVENTION

Here, the reservoir tank is provided between other devices in a bonnet of a four-wheeled vehicle, for example, and a top surface of the storage chamber may be located in a position lower than an upper limit fluid quantity line of the reservoir tank. In a reservoir tank having two storage chambers of a primary chamber and a secondary chamber where the two storage chambers and the inlet of hydraulic oil are aligned in a predetermined direction, when both top surfaces of the two storage chambers are located in positions lower than the upper limit fluid quantity line, if the top surfaces of the two storage chambers are configured as inclined surfaces, as disclosed in WO2015/064638, it is necessary to provide a top surface of the reservoir tank with a communication passage passing through the two storage chambers and leading to the inlet.

However, in a case where the communication passage passing through the two storage chambers is provided on one side surface-side of the reservoir tank, when a fluid level of the hydraulic fluid is tilted forward of the vehicle due to the inertia force that is generated upon deceleration of the vehicle, the hydraulic oil in the storage chamber located on a front-side is leaked further forward, so that the minimum quantity of the hydraulic oil may not be maintained in the storage chamber.

The present invention has been made in view of the above situations, and an object thereof is to provide a reservoir tank capable of efficiently injecting hydraulic oil into two storage chambers and maintaining a minimum quantity of the hydraulic oil in the two storage chambers even though a vehicle is tilted.

According to one aspect of the present invention, there is provided a reservoir tank that is used for a hydraulic system of a vehicle and is configured to store a hydraulic fluid to be fed to a master cylinder. The reservoir tank includes an inlet provided on a top surface of the reservoir tank on one side in a first direction; a first storage chamber and a second storage chamber sequentially provided in the reservoir tank from the other side in the first direction; a first rib connected to the top surface and a bottom surface of the reservoir tank and partitioning the first storage chamber and the second storage chamber; and a second rib connected to the top surface and the bottom surface of the reservoir tank and partitioning the second storage chamber and a space on the one side further from the second storage chamber. The first rib includes a first partitioning part extending in a second direction intersecting with the first direction, one end-side of the first partitioning part in the second direction being connected to one wall surface of the reservoir tank; and a first passage formation part connected to the other end-side of the first partitioning part in the second direction, extending in the first direction, and configured to form a first fluid passage between the first passage formation part and other wall surface facing the one wall surface of the reservoir tank for enabling communication between the first storage chamber and the second storage chamber. The second rib includes a second partitioning part extending in the second direction, the other end-side of the second partitioning part in the second direction being connected to the other wall surface of the reservoir tank; and a second passage formation part connected to one end-side of the second partitioning part in the second direction, extending in the first direction, and configured to form a second fluid passage between the second passage formation part and the one wall surface of the reservoir tank for enabling communication between the second storage chamber and a space on the one side further from the second storage chamber. In a state where the reservoir tank is mounted on the vehicle, a top surface of the first storage chamber is inclined relative to a horizontal plane so that a height position of a connection part with the first fluid passage is highest, a top surface of the second storage chamber is inclined relative to the horizontal plane so that a height position of any one position adjacent to the first partitioning part of the first rib is highest, and the height position of the connection part with the first fluid passage of the top surface of the first storage chamber, a height position of a connection part with the first storage chamber of a top surface of the first fluid passage, the height position of any one position of the top surface of the second storage chamber, a height position of a connection part with the second storage chamber of a top surface of the second fluid passage, and a height position of a connection part with the space on the one side further from the second storage chamber of the top surface of the second fluid passage satisfy a relation of H1≤H2<H3≤H4<H5.

As described above, according to the present invention, it is possible to efficiently inject the hydraulic oil into the two storage chambers and to maintain a minimum quantity of the hydraulic oil in the two storage chambers even though the vehicle is tilted.

### BRIEF DESCRIPTION OF THE DRAWINGS

FIG. 1 is a pictorial view depicting a configuration example of a reservoir tank in accordance with an embodiment of the present invention.

FIG. 2 is a plan view of the reservoir tank shown in FIG. 3 is a I-I sectional view shown in FIG. 1, as seen from an arrow direction.

FIG. 4 is a II-II sectional view shown in FIG. 2, as seen from an arrow direction.

FIG. 5 is a III-III sectional view shown in FIG. 2, as seen from an arrow direction.

FIG. 6 is a IV-IV sectional view shown in FIG. 2, as seen from an arrow direction.

FIG. 7 depicts an aspect where the reservoir tank is tilted forward.

FIG. 8 depicts a height position of a top surface of a connection part of a first storage chamber and a first fluid passage.

FIG. 9 depicts a height position of a top surface of a connection part of a second storage chamber and a second fluid passage.

### DETAILED DESCRIPTION

Hereinbelow, favorable embodiments of the present invention will be described in detail with reference to the accompanying drawings. In the specification and the drawings, the constitutional elements having substantially the same functional configuration are denoted with the same reference signs, and overlapping descriptions are omitted.

(Hydraulic Brake Device)

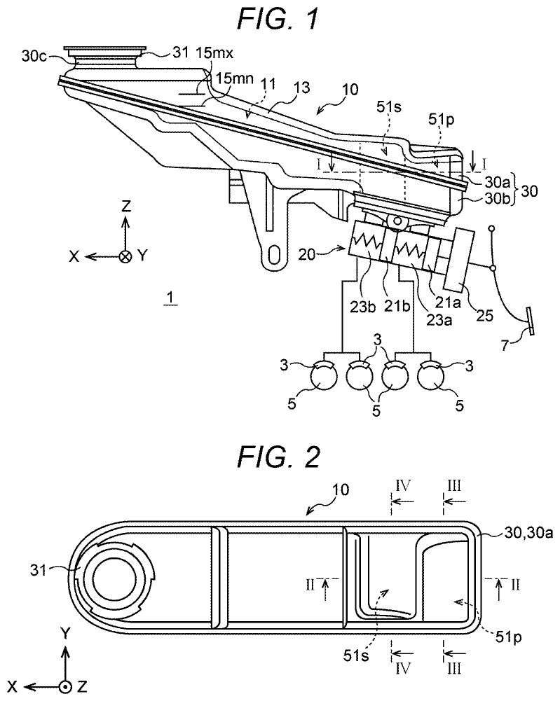

FIG. 1 is a pictorial view depicting a configuration example of a hydraulic brake device in accordance with an embodiment of the present invention. A hydraulic brake device 1 may be configured to be similar to the hydraulic brake device of the related art, except a configuration of a reservoir tank 10.

The hydraulic brake device 1 is a brake device where hydraulic oil (brake oil) is used as a hydraulic fluid. The hydraulic brake device 1 includes a brake pedal 7, a booster 25, a tandem master cylinder 20, the reservoir tank 10 and wheel cylinders 3. The reservoir tank 10 is mounted to the tandem master cylinder 20 fixed to a vehicle body, for example. Also, the reservoir tank 10 is mounted so that a longitudinal direction follows a front and rear direction of a vehicle, for example.

When a driver of the vehicle steps on the brake pedal 7, the booster 25 is actuated, so that a pedal pressure is boosted and output in a predetermined servo ratio. By the output of the booster 25, a primary piston 21a of the tandem master cylinder 20 is actuated to feed the hydraulic fluid in a primary hydraulic fluid chamber 23a to the wheel cylinders 3 of one system. At the same time, a secondary piston 21b is actuated to feed the hydraulic fluid in a secondary hydraulic fluid chamber 23b to the wheel cylinders 3 of the other system. When the hydraulic pressure of the tandem master cylinder 20 is transferred to each of the wheel cylinders 3, each of the wheel cylinders 3 generates a brake force, so that a braking force is generated for each of wheels 5.

The reservoir tank 10 has a receptacle-shaped lower half body 30b opened upward, and an upper half body 30a welded to the lower half body 30b to close an upper opening portion of the lower half body 30b. A tank main body 30 configured by the upper half body 30a and the lower half body 30b has an internal space 11 in which the hydraulic fluid to be fed to the tandem master cylinder 20 is stored.

The upper half body 30a and the lower half body 30b are formed of transparent or semi-transparent resin, for example. An upper part of the upper half body 30a is provided with an inlet 30c, and the inlet 30c is provided with a cap 31 for opening and closing the inlet 30c. In the tank main body 30, a filter (not shown) is provided below the inlet 30c. A side surface of the upper half body 30a is denoted with an upper limit fluid quantity line 15mx indicative of an upper limit fluid quantity of the hydraulic fluid and a lower limit fluid quantity line 15mn indicative of a minimum quantity.

(Configuration Example of Reservoir Tank)

A configuration example of the reservoir tank 10 in accordance with the present embodiment is specifically described with reference to FIGS. 1 to 6. FIG. 1 is a side view of the reservoir tank 10 mounted on the vehicle, as seen from a horizontal direction orthogonal to the longitudinal direction, and the shown right and left direction corresponds to the front and rear direction of the vehicle. In FIG. 1, an axial direction of the tandem master cylinder is inclined relative to the horizontal direction so that a front-side of the vehicle is higher. FIG. 2 is a plan view of the reservoir tank 10 shown in FIG. 1, as seen from above.

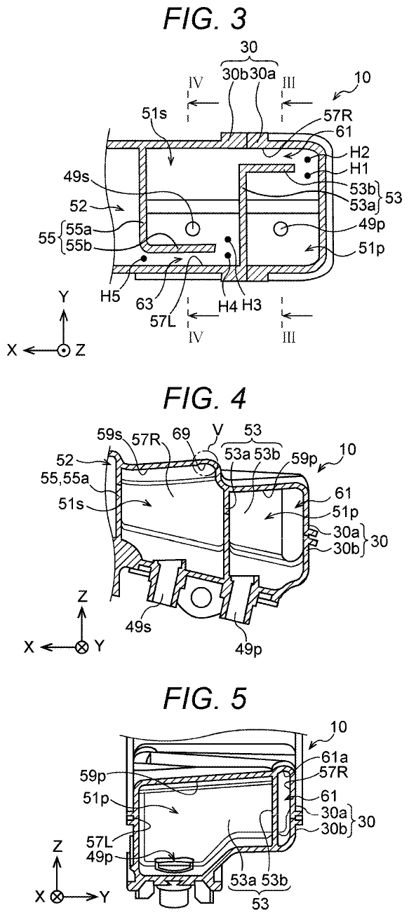

FIG. 3 is a I-I sectional view shown in FIG. 1, as seen from an arrow direction. FIGS. 4 to 6 are a II-II sectional view, a III-III sectional view, and a IV-IV sectional view shown in FIG. 2, as seen from arrow directions. In each drawing, the shown upper and lower direction corresponds to a vertical direction. The sectional views shown in FIGS. 3 to 6 partially depict only a part at which a first storage chamber 51p and a second storage chamber 51s are located.

In the present specification, the front and rear direction of the vehicle is referred to as a first direction, and is denoted with an arrow X. Also, a width direction of the vehicle is referred to as a second direction, and is denoted with an arrow Y. Also, a height direction of the vehicle is denoted with an arrow Z. In the below, when referring to front or rear, it means the front or rear of the vehicle, a side in front of the vehicle corresponds to “one side in the first direction” of the present invention, and a side behind the vehicle corresponds to “the other side in the first direction” of the present invention.

The reservoir tank 10 is inclined so that a front-side becomes higher as a whole along the axial direction of the tandem master cylinder 20. In conformity to this, the internal space 11 of the tank main body 30 is inclined so that a front-side becomes higher as a whole. The inlet 30c is provided at the upper part on the front-side of the reservoir tank 10. The internal space 11 of the reservoir tank 10 is partitioned by a plurality of ribs, so that the first storage chamber 51p and the second storage chamber 51s are formed on a rear-side of the internal space 11.

The first storage chamber 51p and the second storage chamber 51s are provided in order of the first storage chamber 51p and the second storage chamber 51s from the rear-side. A bottom surface of the first storage chamber 51p is provided with a hydraulic fluid supply port 49p that communicates with the primary hydraulic fluid chamber 23a of the tandem master cylinder 20. Also, a bottom surface of the second storage chamber 51s is provided with a hydraulic fluid supply port 49s that communicates with the secondary hydraulic fluid chamber 23b of the tandem master cylinder 20.

The first storage chamber 51p and the second storage chamber 51s are partitioned from each other by a first rib 53 connected to a top surface and a bottom surface of the reservoir tank 10. The second storage chamber 51s and a space 52 on a further forward side than the second storage chamber 51s are partitioned from each other by a second rib 55 connected to the top surface and the bottom surface of the reservoir tank 10. Note that, “the top surface” and “the bottom surface” of the reservoir tank 10 are an upper surface and a bottom surface of the internal space 11 of the reservoir tank 10, and mean a surface of an upper part of the upper half body 30a or a bottom part of the lower half body 30b.

The first rib 53 includes a first partitioning part 53a extending in the second direction Y and a first passage formation part 53b extending in the first direction X. The first partitioning part 53a is connected to one wall surface 57L of the reservoir tank 10 on one end-side in the second direction Y. In the reservoir tank 10 of the present embodiment, the first partitioning part 53a is connected to the wall surface 57L of the reservoir tank 10 on the one end-side corresponding to a left side of the vehicle. The first passage formation part 53b is connected to the other end-side of the first partitioning part 53a in the second direction Y and extends rearward. The first passage formation part 53b is arranged spaced from the other wall surface 57R of the reservoir tank 10 located on the other end-side in the second direction Y corresponding to a right side of the vehicle, thereby forming a first fluid passage 61 between the first passage formation part and the other wall surface 57R.

The first fluid passage 61 connects to the second storage chamber 51s on a front-side and connects to the first storage chamber 51p on a rear-side, thereby enabling communication between the first storage chamber 51p and the second storage chamber 51s. Atop surface of the first fluid passage 61 is formed so that a height position becomes higher from the rear toward the front (refer to FIG. 4).

Also, the second rib 55 includes a second partitioning part 55a extending in the second direction Y and a second passage formation part 55b extending in the first direction X. The second partitioning part 55a is connected to the other wall surface 57R of the reservoir tank 10 on the other end-side in the second direction Y. In the reservoir tank 10 of the present embodiment, the second partitioning part 55a is connected to the wall surface 57R of the reservoir tank 10 on the other end-side corresponding to the right side of the vehicle. The second passage formation part 55b is connected to one end-side of the second partitioning part 55a in the second direction Y and extends rearward. The second passage formation part 55b is arranged spaced from the one wall surface 57L of the reservoir tank 10 located on the one end-side in the second direction Y corresponding to the left side of the vehicle, thereby forming a second fluid passage 63 between the second passage formation part and the one wall surface 57L.

The second fluid passage 63 connects to the space 52 on a front-side and connects to the second storage chamber 51s on a rear-side, thereby enabling communication between the second storage chamber 51s and the space 52 on the further forward side than the second storage chamber 51s. Atop surface of the second fluid passage 63 is formed so that a height position becomes higher from the rear toward the front.

In this way, the first storage chamber 51p and the second storage chamber 51s are connected to each other by the first fluid passage 61, and the second storage chamber 51s and the space 52 on the further forward side than the second storage chamber 51s are connected to each other by the second fluid passage 63. The hydraulic fluid that is injected into the internal space 11 of the reservoir tank 10 via the inlet 30c flows from the space 52 into the second storage chamber 51s via the second fluid passage 63, and also flows into the first storage chamber 51p via the first fluid passage 61.

A top surface 59p of the first storage chamber 51p and a top surface 59s of the second storage chamber 51s are all located in positions lower than the upper limit fluid quantity line 15mx. The top surface 59p of the first storage chamber 51p and the top surface 59s of the second storage chamber 51s may also be all located in positions lower than or higher than the lower limit fluid quantity line 15mn. The top surface 59p of the first storage chamber 51p is inclined relative to a horizontal plane so that a height position H1 is highest at the connection part with the first fluid passage 61. Specifically, the top surface 59p of the first storage chamber 51p is formed so that a height position becomes higher from the one wall surface 57L toward the other wall surface 57R of the reservoir tank 10 and becomes higher from the front toward the rear (refer to FIGS. 4 and 5).

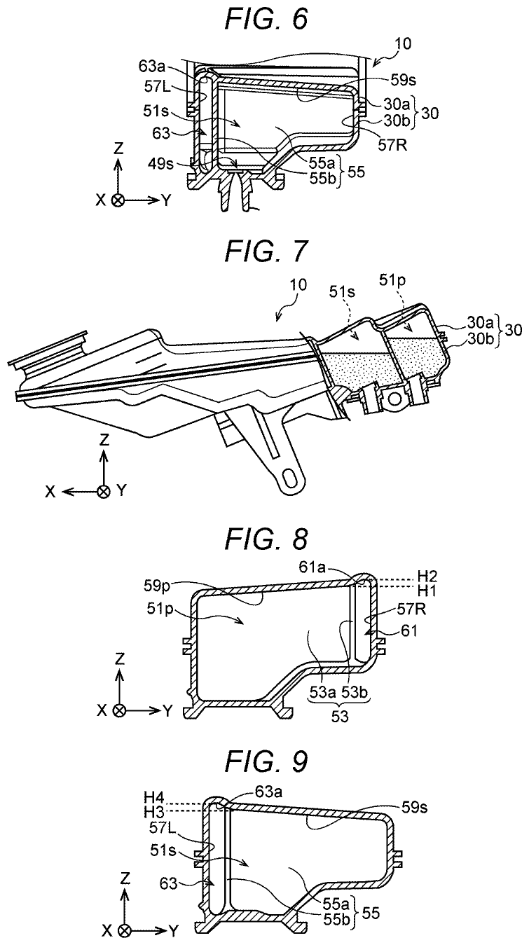

Also, the top surface 59s of the second storage chamber 51s is inclined relative to the horizontal plane so that a height position H3 of any one position adjacent to the first partitioning part 53a of the first rib 53 is highest. In the present embodiment, the top surface 59s of the second storage chamber 51s is inclined relative to the horizontal plane so that the height position H3 is highest at the connection part with the second fluid passage 63. Specifically, the top surface 59s of the second storage chamber 51s is formed so that a height position becomes higher from the other wall surface 57R toward the one wall surface 57L of the reservoir tank 10 and becomes higher from the front toward the rear (refer to FIGS. 4 and 6).

The reservoir tank 10 configured as described above satisfies a following relation.

H1≤H2<H3≤H4<H5

H1: the height position of the connection part with the first fluid passage 61 of the top surface 59p of the first storage chamber 51p

H2: the height position of the connection part with the first storage chamber 51p of a top surface 61a of the first fluid passage 61

H3: the highest height position of the top surface 59s of the second storage chamber 51s

H4: the height position of the connection part with the second storage chamber 51s of a top surface 63a of the second fluid passage 63

H5: the height position of the connection part with the space 52 of the top surface 63a of the second fluid passage 63

For this reason, when the hydraulic fluid is injected into the internal space 11 from the inlet 30c in a state shown in FIG. 1, the hydraulic fluid is sequentially supplied from the space 52 into the second fluid passage 63, the second storage chamber 51s, the first fluid passage 61, and the first storage chamber 51p. When injecting the hydraulic oil into the reservoir tank 10, if the air remains in the hydraulic fluid, an actual hydraulic fluid quantity may be deficient with respect to the minimum quantity.

In contrast, according to the reservoir tank 10 of the present embodiment, as the hydraulic fluid flows into the first storage chamber 51p, the air is discharged to the second storage chamber 51s via the first fluid passage 61. At this time, the top surface 59p of the first storage chamber 51p is formed so that the height position H1 of the connection part with the first fluid passage 61 is highest. For this reason, the inside air is pushed out into the first fluid passage 61 until just before the first storage chamber 51p is filled with the hydraulic fluid. Since the top surface 61a of the first fluid passage 61 is formed so that the height position becomes higher from the rear toward the front, the air pushed into the first fluid passage 61 moves to the second storage chamber 51s.

Also, the top surface 59s of the second storage chamber 51s is formed so that the height position H3 of the connection part with the second fluid passage 63 is highest. For this reason, the inside air is pushed out into the second fluid passage 63 until just before the second storage chamber 51s is filled with the hydraulic fluid. Since the top surface 63a of the second fluid passage 63 is formed so that the height position becomes higher from the rear toward the front, the air pushed into the second fluid passage 63 moves to the space 52 on the further forward side than the second storage chamber 51s. In this way, the reservoir tank 10 of the present embodiment can suppress the air from remaining in the first storage chamber 51p and the second storage chamber 51s when injecting the hydraulic fluid.

Also, according to the reservoir tank 10 of the present embodiment, even though the reservoir tank 10 is tilted forward during rapid deceleration of the vehicle or traveling on a downslope, it is possible to maintain a sufficient quantity of the hydraulic fluid in the first storage chamber 51p and the second storage chamber 51s.

FIG. 7 depicts a state of the hydraulic fluid in the first storage chamber 51p and the second storage chamber 51s when the reservoir tank 10 is tilted forward. In the reservoir tank 10 of the present embodiment, the connection part of the first storage chamber 51p and the first fluid passage 61 is provided on the rear-side of the first storage chamber 51p, and the front-side of the first storage chamber 51p is configured by a closed space. For this reason, even though the reservoir tank 10 is tilted forward, the leakage of the hydraulic fluid from the first storage chamber 51p toward the second storage chamber 51s is suppressed, so that it is possible to maintain a predetermined quantity of the hydraulic fluid in the first storage chamber 51p.

Similarly, the connection part of the second storage chamber 51s and the second fluid passage 63 is provided on the rear-side of the second storage chamber 51s. For this reason, even though the reservoir tank 10 is tilted forward, the leakage of the hydraulic fluid from the second storage chamber 51s toward the space 52 on the further forward side is suppressed, so that it is possible to maintain a predetermined quantity of the hydraulic fluid in the second storage chamber 51s.

In the reservoir tank 10 of the present embodiment, as shown in FIG. 8, at the connection part of the first storage chamber 51p and the first fluid passage 61, the height position H2 of the top surface 61a of the first fluid passage 61 may be higher than the height position H1 of the top surface 59p of the first storage chamber 51p (H2>H1). Thereby, it is possible to efficiently move the air discharged from the first storage chamber 51p to the first fluid passage 61.

Similarly, as shown in FIG. 9, at the connection part of the second storage chamber 51s and the second fluid passage 63, the height position H4 of the top surface 63a of the second fluid passage 63 may be higher than the height position H3 of the top surface 59s of the second storage chamber 51s (H4>H3). Thereby, it is possible to efficiently move the air discharged from the second storage chamber 51s to the second fluid passage 63.

When the reservoir tank 10 has all the configurations shown in FIGS. 8 and 9, the relation of the above height positions satisfies a following relation.

H1<H2<H3<H4<H5

When the above relation is satisfied, the air can be efficiently discharged from the first storage chamber 51p to the space 52 on the further forward side than the second storage chamber 51s in order of the first fluid passage 61, the second storage chamber 51s and the second fluid passage 63.

Also, as shown with a range surrounded by the dashed-dotted line V in FIG. 4, the top surface 59s of the second storage chamber 51s may have an upward concave portion 69 connected to at least the top surface 63a of the second fluid passage 63 on the rear-side in the first direction X. The upward concave portion 69 is provided, so that the air discharged from the first storage chamber 51p via the first fluid passage 61 can be moved to the second fluid passage 63. Also, the upward concave portion 69 may be connected to each of the top surface 61a of the first fluid passage 61 and the top surface 63a of the second fluid passage 63. Thereby, the air discharged from the first storage chamber 51p via the first fluid passage 61 is difficult to move toward the front-side of the top surface 59s of the second storage chamber 51s, so that the air can be more efficiently moved to the second fluid passage 63.

As described above, according to the reservoir tank 10 of the present embodiment, when injecting the hydraulic fluid from the inlet 30c provided on the front-side, it is possible to supply the hydraulic fluid to the first storage chamber 51p and the second storage chamber 51s while efficiently discharging the air from each of the first storage chamber 51p and the second storage chamber 51s provided on the rear-side. Thereby, it is possible to suppress the air from remaining in the first storage chamber 51p and the second storage chamber 51s.

Also, according to the reservoir tank 10 of the present embodiment, the connection part of the first storage chamber 51p and the first fluid passage 61 is provided on the rear-side of the first storage chamber 51p, and the connection part of the second storage chamber 51s and the second fluid passage 63 is provided on the rear-side of the second storage chamber 51s. Therefore, even though the reservoir tank 10 is tilted forward during the rapid deceleration of the vehicle or traveling on the downslope, it is possible to maintain the sufficient quantity of the hydraulic fluid in the first storage chamber 51p and the second storage chamber 51s.

Although the favorable embodiment of the present invention has been described with reference to the accompanying drawings, the present invention is not limited to the embodiment. It is apparent to one skilled in the art of the present invention that a variety of changes or modifications can be made within the scope of the technical spirit defined in the claims, which are also understood to be included within the technical scope of the present invention.

For example, in the above embodiment, the top surface 59s of the second storage chamber 51s is formed so that the height position becomes higher from the front toward the rear in the first direction X and becomes higher from the other wall surface 57R toward the one wall surface 57L. However, the present invention is not limited thereto. The top surface 59s of the second storage chamber 51s may also be formed so that the height position becomes higher from the front toward the rear in the first direction X and becomes higher from the one wall surface 57L toward the other wall surface 57R. In this case, when a rear part of the top surface 59s is provided with a passage connected to the second fluid passage 63 and formed so that a height position of a top surface becomes higher from the other wall surface 57R toward the one wall surface 57L, it is possible to efficiently discharge the air from the first storage chamber 51p and the second storage chamber 51s into the space 52.

Also, in the above embodiment, the Y direction that is the second direction is a direction directed from the left toward the right in the vehicle width direction. However, the second direction of the present invention is not limited thereto. For example, the second direction may be a direction directed from the right toward the left in the vehicle width direction, and the configuration of the first storage chamber 51p and the second storage chamber 51s may be bilaterally symmetrical to the configuration of the first storage chamber 51p and the second storage chamber 51s of the above embodiment.

What is claimed is:

1. A reservoir tank (10) that is used for a hydraulic system (1) of a vehicle and is configured to store a hydraulic fluid to be fed to a master cylinder (20), the reservoir tank comprising:
an inlet (30c) provided on a top surface of the reservoir tank (10) on one side in a first direction (X);
a first storage chamber (51p) and a second storage chamber (51s) sequentially provided in the reservoir tank (10) from the other side in the first direction (X);
a first rib (53) connected to the top surface and a bottom surface of the reservoir tank (10) and partitioning the first storage chamber (51p) and the second storage chamber (51s); and
a second rib (55) connected to the top surface and the bottom surface of the reservoir tank (10) and partitioning the second storage chamber (51s) and a space (52) on the one side further from the second storage chamber (51s),
wherein the first rib (53) comprises:
a first partitioning part (53a) extending in a second direction Y intersecting with the first direction (X), one end-side of the first partitioning part (53a) in the second direction (Y) being connected to one wall surface (57L) of the reservoir tank (10); and
a first passage formation part (53b) connected to the other end-side of the first partitioning part (53a) in the second direction (Y), extending in the first direction (X), and configured to form a first fluid passage (61) between the first passage formation part (53b) and other wall surface (57R) facing the one wall surface (57L) of the reservoir tank (10) for enabling communication between the first storage chamber (51p) and the second storage chamber (51s),
wherein the second rib (55) comprises:
a second partitioning part (55a) extending in the second direction (Y), the other end-side of the second partitioning part (55a) in the second direction (Y) being connected to the other wall surface (57R) of the reservoir tank (10); and
a second passage formation part (55b) connected to the one end-side of the second partitioning part (55a) in the second direction (Y), extending in the first direction (X), and configured to form a second fluid passage (63) between the second passage formation part (55b) and the one wall surface (57L) of the reservoir tank (10) for enabling communication between the second storage chamber (51s) and the space (52) on the one side further from the second storage chamber (51s), and
wherein in a state where the reservoir tank (10) is mounted on the vehicle,
a top surface (59p) of the first storage chamber (51p) is inclined relative to a horizontal plane so that a height position (H1) of a connection part with the first fluid passage (61) is highest,
a top surface (59s) of the second storage chamber (51s) is inclined relative to the horizontal plane so that a height position (H3) of any one position adjacent to the first partitioning part (53a) of the first rib (53) is highest, and
the height position (H1) of the connection part with the first fluid passage (61) of the top surface (59p) of the first storage chamber (51p),
a height position (H2) of a connection part with the first storage chamber (51p) of a top surface (61a) of the first fluid passage (61),
the height position (H3) of any one position of the top surface (59s) of the second storage chamber (51s),
a height position (H4) of a connection part with the second storage chamber (51s) of a top surface (63a) of the second fluid passage (63), and
a height position (H5) of a connection part with the space (52) on the one side further from the second storage chamber (51s) of the top surface (63a) of the second fluid passage (63) satisfy a relation of H1≤H2<H3≤H4<H5.

2. The reservoir tank according to claim 1, wherein the top surface (59s) of the second storage chamber (51s) is inclined relative to the horizontal plane so that a connection part with the second fluid passage (63) is highest.

3. The reservoir tank according to claim 2, wherein each of the top surface (59p) of the first storage chamber (51p) and the top surface (59s) of the second storage chamber (51s) is formed so that the height position becomes higher from the one side toward the other side in the first direction (X).

4. The reservoir tank according to claim 3, wherein the top surface (59p) of the first storage chamber (51p) is formed so that the height position becomes higher from the one end-side toward the other end-side in the second direction (Y).

5. The reservoir tank according to claim 4, wherein the height position (H2) of the connection part with the first storage chamber (51p) of the top surface (61a) of the first fluid passage (61) is higher than the height position (H1) of the connection part with the first fluid passage (61) of the top surface (59p) of the first storage chamber (51p).

6. The reservoir tank according to claim 5, wherein the height position (H4) of the connection part with the second storage chamber (51s) of the top surface (63a) of the second fluid passage (63) is higher than the height position (H3) of any one position of the top surface (59s) of the second storage chamber (51s).

7. The reservoir tank according to claim 6, wherein the top surface (59s) of the second storage chamber (51s) is provided on the other side in the first direction (X) with an upward concave portion (69) connected to each of the top surface (61a) of the first fluid passage (61) and the top surface (63a) of the second fluid passage (63).

8. The reservoir tank according to claim 1, wherein each of the top surface (59p) of the first storage chamber (51p) and the top surface (59s) of the second storage chamber (51s) is formed so that the height position becomes higher from the one side toward the other side in the first direction (X).

9. The reservoir tank according to claim 1, wherein the top surface (59p) of the first storage chamber (51p) is formed so that the height position becomes higher from the one end-side toward the other end-side in the second direction (Y).

10. The reservoir tank according to claim 1, wherein the height position (H2) of the connection part with the first storage chamber (51p) of the top surface (61a) of the first fluid passage (61) is higher than the height position (H1) of the connection part with the first fluid passage (61) of the top surface (59p) of the first storage chamber (51p).

11. The reservoir tank according to claim 1, wherein the height position (H4) of the connection part with the second storage chamber (51s) of the top surface (63a) of the second fluid passage (63) is higher than the height position (H3) of any one position of the top surface (59s) of the second storage chamber (51s).

12. The reservoir tank according to claim 1, wherein the top surface (59s) of the second storage chamber (51s) is provided on the other side in the first direction (X) with an upward concave portion (69) connected to each of the top surface (61a) of the first fluid passage (61) and the top surface (63a) of the second fluid passage (63).
